(19) United States
(12) Patent Application Publication
(10) Pub. No.: US 2021/0189153 A1
(43) Pub. Date: Jun. 24, 2021

(54) IMPROVED APPARATUS AND USES AND METHODS RELATING THERETO

(71) Applicant: POLYSEAM LIMITED, Huddersfield (GB)

(72) Inventors: Wolodymyr HLUCHAN, Huddersfield (GB); Kjetil BOGSTAD, Huddersfield (GB)

(21) Appl. No.: 16/754,197

(22) PCT Filed: Nov. 2, 2018
(86) PCT No.: PCT/GB2018/053184

§ 371 Date: Apr. 7, 2020

(30) Foreign Application Priority Data
Nov. 17, 2017 (GB) 1719025.7

(51) Int. Cl. C09D 5/18; C09D 131/04; E04B 1/76; E04B 1/80; E04B 1/94

(52) U.S. Cl. CPC C09D 5/18; C09D 131/04; C08K 2003/2227; E04B 1/80; E04B 1/942; E04B 1/7658

(57) ABSTRACT

A method of improving at least one property of a partition wall, the method comprising positioning an insert panel inside the partition wall wherein the insert panel comprises a mineral fibre board coated on at least one side with a polymer forming composition comprising a fire retardant compound.

The present invention relates to improvements in barriers and in particular in relation to partition walls.

Partition walls are used within buildings to divide space. They may be used, for example, in a domestic environment or they may be used in offices or other commercial settings. These are not load bearing structures, making them relatively simple to assemble and dismantle. Partition walls typically comprise a support and two panels, for example a frame covered on each side by a panel leaving a cavity between the panels.

Various different materials can be used to construct partition walls. The choice of suitable materials is determined by the intended use of the space being divided, the desired function and properties of the partition and, of course, cost.

The properties of the partition are often important and certain materials may be used to provide a particular level of acoustic performance, fire resistance or thermal insulation, for example.

As well as the choice of material, the properties of the wall may be altered by changing the space between the panels that make up the partition wall. In some embodiments a further panel of material may be fitted within the cavity. Sometimes multiple panels are needed to give the desired properties. However, it is desirable to keep the total wall thickness to a minimum for space saving reasons.

The present inventors have developed means by which properties of a partition wall can be significantly improved.

According to a first aspect of the present invention there is provided a method of improving at least one property of a partition wall, the method comprising positioning an insert panel inside the partition wall wherein the insert panel comprises a mineral fibre board coated on at least one side with a polymer forming composition comprising a fire retardant compound.

According to a second aspect of the present invention there is provided a partition wall comprising a support structure and two exterior panels arranged to provide a cavity between said exterior panels wherein an insert panel is positioned within the cavity and wherein the insert panel comprises a mineral fibre board coated on at least one side with a polymer forming composition comprising a fire retardant compound.

According to a third aspect of the present invention there is provided the use of an insert panel within the cavity of a partition wall to improve at least one property of said partition wall wherein said insert panel comprises a mineral fibre board coated on at least one side with a polymer forming composition comprising a fire retardant compound.

Preferred features of the first, second and third aspects of the present invention will now be described.

The present invention relates to improvements in relation to a partition wall.

The partition wall comprises a support structure and two exterior panels. The term “exterior panel” is used to emphasise that said panels form the outermost part of the wall.

The support structure and exterior panels may be made from any suitable material, for example any material typically used in the construction of partition walls. Such materials will be well known to the person skilled in the art.

The support structure may vary according to the design of the partition wall. In some embodiments the support structure may comprise tracking or positioners fixed to the floor and/or ceiling and/or surrounding walls which are used to secure the exterior panels in position.

In preferred embodiments the support structure comprises a frame which is covered on each side by the exterior panels.

Such a frame may be made from any suitable material, for example metal, wood or plastic.

The exterior panels may be made from any suitable material commonly used in the construction of partition walls.

Materials that may be used for the exterior panels include metal sheets, glass, plastic, plasterboard, gypsum, magnesium or calcium silicates, cementitious materials, oriented strand board, plywood and chipboard.

In preferred embodiments of the present invention the support structure of the partition wall comprises a timber frame and the two exterior panels are made from plasterboard. Thus the third aspect of the present invention may provide a timber frame covered on each side with plasterboard panels and having an insert panel positioned between said plasterboard panels.

The insert panel comprises a mineral fibre board. Any mineral fibre board could be used, and materials of this type are known to the person skilled in the art. A preferred material is stonewool fibre board. Various grades of such material are available having different densities and thickness. The selection of a suitable grade will depend on the desired properties depending on the intended use. The selection of a suitable material will be within the competence of the skilled person.

In the insert panel of the present invention mineral fibre board is coated on at least one side with a polymer forming composition comprising a fire retardant compound.

In preferred embodiments both sides of the mineral fibre board are coated with the polymer forming composition.

The polymer forming composition is suitably a dispersion of monomers in a solvent which may be easily applied to a surface. The composition suitably forms a polymer on drying or curing.

Curing may be carried out for example by application of heat or radiation, such as UV radiation. Preferably the composition forms a polymer on drying. Preferably heat is used to assist drying.

Preferably the polymer forming composition comprises one or more monomers selected from ethylene, propylene, vinyl derived polymers, acrylic acid derived polymers and styrene or styrene derived polymers.

Preferably the polymer forming composition comprises vinyl acetate based monomers. More preferably the polymer forming composition comprises ethoxylated vinyl acetate monomers.

The polymer forming composition comprises one or more monomers. These are suitably present as a dispersion or emulsion in a solvent. The solvent may be aqueous or non-aqueous. Preferred solvents are water and water miscible solvents, for example water soluble alcohols and esters. Most preferably the solvent is water.

In some especially preferred embodiments the polymer forming composition comprises an aqueous emulsion of ethoxylated vinyl acetate.

The polymer forming composition suitably comprises at least 1 wt % monomers, preferably at least 2 wt %, suitably at least 3 wt %, more preferably at least 5 wt %, for example at least 10 wt %.

Suitably the polymer forming composition may comprise up to 60 wt % monomers, preferably up to 50 wt %, suitably up to 40 wt %, more preferably up to 30 wt %, for example up to 20 wt %.

The polymer forming composition may comprise a mixture of monomers which react to form a copolymer. The copolymer may be a random, alternating or block copolymers. In such embodiments the above amounts refer to the total amount of all monomers present in the composition.

The polymer forming composition comprises a fire retardant compound.

Any suitable fire retardant compound may be used.

By fire retardant compound we mean to refer to a compound which prevents or inhibits the spread of fire.

Such compounds do not burn. Preferably they char and/or swell.

Preferred fire retardant compounds do not contain any halogen atoms.

Suitable fire retardant compounds for use herein include metal hydroxides, exfoliated graphite, metal silicates (e.g. sodium metasilicate), phosphate sources (e.g. ammonium polyphosphate), pentaerythritol, and melamine.

Preferred fire retardant compounds are metal hydroxides, especially magnesium and/or aluminium hydroxide.

Most preferably the fire retardant compound comprises aluminium trihydroxide.

Suitably the fire retardant compound is present in an amount at least 0.1 wt %, preferably at least 0.5 wt %, more preferably at least 1 wt %, preferably least 2 wt %.

Suitably the fire retardant compound is present in an amount of up to 40 wt %, preferably to 20 wt %, suitably up to 15 wt %, for example up to 10 wt %.

The polymer forming composition may comprise a mixture of fire retardant compounds. In such embodiments the above amounts refer to the total amount of all such compounds present in the composition.

In some preferred embodiments the polymer forming composition further comprises one or more fillers.

Suitable fillers include calcium carbonate, dolomite, limestone, chalk, marble, calcite, whitings, aluminium silicates, barytes, talc, aluminium dioxide, magnesium hydroxide, silicates.

Some preferred fillers for use herein include titanium dioxide and dolomite.

Dolomite is an especially preferred filler.

The filler is preferably present in the polymer forming composition in an amount of at least 5 wt %, preferably at least 10 wt %, more preferably at least 20 wt %, for example at least 30 wt %.

The filler is preferably present in the polymer forming composition in an amount of up to 70 wt %, suitably up to 50 wt %, for example up to 40 wt %.

The polymer forming composition may comprise a mixture of fillers. In such embodiments the above amounts refer to the total amount of all such compounds present in the composition.

Preferably the polymer forming composition comprises at least 5 wt % dolomite, preferably at least 10 wt %, more preferably at least 20 wt %, suitably at least 30 wt %.

Preferably the polymer forming composition comprises up to 50 wt % dolomite, suitably up to 40 wt %, preferably up to 35 wt %.

Preferably the polymer forming composition comprises at least 0.1 wt % titanium dioxide, preferably at least 0.5 wt %, suitably at least 1 wt %.

Preferably the polymer forming composition comprises up to 10 wt % titanium dioxide, preferably up to 5 wt %, suitably up to 3 wt %.

In some preferred embodiments the polymer forming composition comprises vinyl acetate derived monomers; aluminium trihydroxide; dolomite; and titanium dioxide.

More preferably the polymer forming composition comprises
10 to 20 wt % ethoxylated vinyl acetate monomors;
1 to 15 wt % aluminium trihydroxide;
25 to 40 wt % dolomite; and
0.1 to 5 wt % titanium dioxide.

Preferably the polymer forming composition comprises less than 1 wt % migratory molecules, preferably less than 0.01 wt %.

By migratory molecules we mean small organic molecules such as minerals oils or plasticisers.

Preferably the polymer forming composition comprises less then 1 wt % phthalate compounds, preferably less than 0.1 wt %, more preferably less than 0.01 wt % or less than 0.001 wt %. Preferably the polymer forming composition is substantially free from phthalate compounds.

The polymer forming composition may be applied to the mineral fibre board by any suitable means, for example by spraying, dipping or painting. A preferred application method is spraying.

The polymer forming composition provides a coating on the mineral fibre board. Preferably the thickness of the coating is from 500 to 1500 μm, more preferably from 800 to 1000 μm.

The provision of the coating on the mineral fibre board of the insert panel of the present invention reduces the permeableability of the mineral fibre core to air, smoke and hot gases as well as improving sound insulation.

Preferably the insert panel is substantially impermeable to air.

The insert panel of the present invention may be suitably placed within the cavity of a partition wall to improve a property of said partition wall.

Suitably the use of the insert panel within the cavity may improve one or more properties of the partition wall selected from thermal insulation, fire retardancy and acoustic performance.

In some embodiments the use of the insert panel increases the fire resistance compared with an equivalent partition wall which does not comprise the insert panel. The improvement may be measured according to a standard test.

Fire resistance tests by which improved performance may be measured include EN1364-1 and EN1363-1 for non load bearing partition systems; EN1366-3 for penetrating services; and EN1366-1 for ventilation ducts.

In some embodiments the use of the insert panel of the present invention improves the acoustic performance of the partition wall compared with an equivalent partition wall which does not comprise the insert panel. Acoustic performance may be measured by a standard test, for example Airborne sound EN 10140-2 for airborne sound or EN10140-3 for impact sound.

Suitably the use of the insert panel of the present invention within the cavity of the partition wall improves the thermal insulation provided by the partition wall compared with an equivalent partition wall which does not comprise the insert panel. The thermal insulation may be measured by a standard test method for example EN12664, EN12667, or EN12939.

The insert panel of the present invention preferably has high performance in relation to acoustic performance, thermal insulation and fire resistance. Because of its superior performance the insert panel need not be very thick. Suitably the insert panel has a thickness less than 15 cm, more preferably less than 10 cm. Suitably the insert panel has a thickness of 2 to 8 cm, more preferably from 3 to 6 cm, preferably from 3 to 5 cm.

With many partition walls of the prior art, in order to achieve desired fire resistance, acoustic performance or thermal insulation rating, specialist materials would have to be used in the construction of the wall, for example the exterior panels may be composed of a higher performing material. These higher performing materials are typically more costly and can be difficult to source, potentially leading to delays in construction. The method of the present invention allows regular plasterboard to be used to provide walls having superior properties. In addition the insert panel of the present invention can be retrofitted into existing partition walls to improve one or more properties of the existing wall.

The present invention does not require multiple panels to be inserted within the cavity of the partition wall. It can also help achieve a particular level of performance without having to increase the thickness of the wall. In some partition walls of the prior art, wall thickness could be increase to improve properties by increasing the thickness of the exterior panels and/or by increasing the depth of the cavity. Both of these take up floor space and are thus undesitable. Thicker exterior panels are often more costly, can require stronger support structures and may be more difficult to fit.

Preferably the partition wall of the third aspect has a total thickness (from external surface to external surface of the exterior panels) of less than 20 cm, preferably less than 15 cm, suitably less than 10 cm.

The present invention will now be further described with reference to the accompanying drawings and the following non limiting examples.

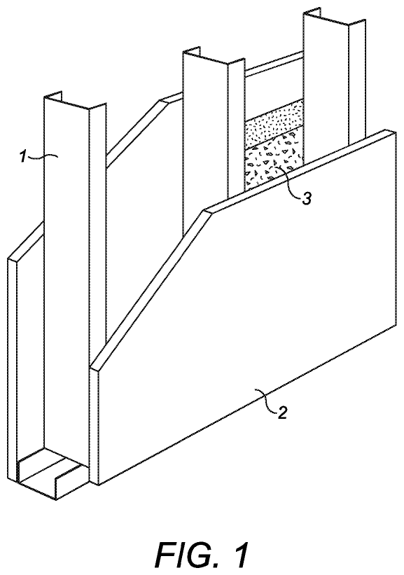

The insulation panel of the present invention may be fitted within a partition wall as shown in FIG. 1.

FIG. 1 shows a partition wall consisting of a frame 1 and two exterior panels 2. The insert panel of the present invention 3 is positioned in the cavity between the exterior panels of the partition wall.

### EXAMPLE

A polymer forming coating composition was prepared comprising the following components:
ethoxylated vinyl acetate—15 wt %
aluminium hydroxide—6 wt %
titanium dioxide—2 wt %
dolomite—32 wt %
Water—balance.

This composition applies to both sides of a stonewall mineral board of thickness 5 cm.

The coating was sprayed onto each side of the board and left to dry for 2 to 4 hours at 40° C.

The coated panel was inserted into a partition wall of standard construction comprising two plasterboard panels of thickness 12.5 mm attached to a timber frame.

Tests were carried out to compare the acoustic performance, fire resistance and thermal insulation of the partition wall of the invention with an equivalent partition wall which did not contain the insert panel. In each cause inclusion of the insert panel led to improved performance.

1. A method of improving at least one property of a partition wall, the method comprising positioning an insert panel inside the partition wall wherein the insert panel comprises a mineral fibre board coated on at least one side with a polymer forming composition comprising a fire retardant compound.

2. A partition wall comprising a support structure and two exterior panels arranged to provide a cavity between said exterior panels wherein an insert panel is position within the cavity and wherein the insert panel comprises a mineral fibre board coated on at least one side with a polymer forming composition comprising a fire retardant compound.

3. (canceled)

4. The method of claim 1, wherein the mineral fibre board is coated on both sides with the polymer forming composition.

5. The method of claim 1, wherein the polymer forming composition comprises vinyl acetate derived monomers.

6. The method of claim 1, wherein the fire retardant compound comprises aluminium trihydroxide.

7. The method of claim 1, wherein the polymer forming composition further comprises a filler.

8. The method of claim 7 wherein the filler comprises dolomite and titanium dioxide.

9. The method of claim 1, which improves one or more properties selected from acoustic performance, fire resistance and thermal insulation.

10. The partition wall of claim 2, wherein the mineral fibre board is coated on both sides with the polymer forming composition.

11. The partition wall of claim 2, wherein the polymer forming composition comprises vinyl acetate derived monomers.

12. The partition wall of claim 2, wherein the fire retardant compound comprises aluminium trihydroxide.

13. The partition wall of claim 2, wherein the polymer forming composition further comprises a filler.

14. The partition wall of claim 13, wherein the filler comprises dolomite and titanium dioxide.
